(19) United States
(12) Patent Application Publication
(10) Pub. No.: US 2010/0246890 A1
(43) Pub. Date: Sep. 30, 2010

(54) DETECTION OF OBJECTS IN IMAGES

(75) Inventors: Eyal Ofek, Redmond, WA (US); Ido Omer, Medina, WA (US); Michael Kroepfl, Redmond, WA (US); Mark Tabb, Estes Park, CO (US); Kartik Muktinutalapati, Westminster, CO (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/411,398

(22) Filed: Mar. 26, 2009

(51) Int. Cl. G06K 9/00

(52) U.S. Cl. 382/105

(57) ABSTRACT

A system described herein includes a detector component that automatically determines location of a license plate in a digital image. The system further includes a blurrer component that automatically blurs the digital image at the determined location of the license plate, wherein blurring undertaken by the blurrer component is based at least in part upon confidence scores assigned to pixels in the digital image that correspond to the determined location of the license plate.

### BACKGROUND

License plate detection systems are conventionally used in scenarios where digits of a license plate are desirably deciphered. For example, in some conventional systems, a digital camera may be positioned proximate to a stoplight and configured to capture images of a portion of an automobile that typically includes a license plate. A sensor may be used in connection with detecting when an automobile passes through a red light, for instance, and responsive to receipt of an output from the sensor, the digital camera can capture an image of the automobile. The digital camera is typically positioned such that the field of view of the digital camera is approximately orthogonal to the license plate.

In another example, automatic detection of license plates in digital images may be desirable in connection with a toll booth. Specifically, many roadways and/or bridges require users to pay toll, wherein proceeds of the tolls are used in connection with maintaining such roads or bridges. To decrease costs associated with collecting tolls, many tollbooths have been designed to operate without being manned by a human toll collector. To ensure that drivers pay tolls, a digital camera can be configured to capture images of vehicles as they pass the tollbooth. An automated license plate detection system may then be used in connection with reading digits from the license plate and finding those that do not stop to pay the toll.

While these automatic license plate detection systems typically operate with sufficient accuracy when the license plate is approximately orthogonal to the field of view of the camera, such license plate detection systems are suboptimal or inoperable when an image of a license plate is captured at an oblique angle. That is, the automatic license plate detection system may be unable to determine where the license plate is on the vehicle in the digital image and may be unable to decipher digits on such license plates.

### SUMMARY

The following is a brief summary of subject matter that is described in greater detail herein. This summary is not intended to be limiting as to the scope of the claims.

Described herein are various technologies pertaining to automatically detecting certain objects in a captured digital image. Objects that can be detected using the technology described herein include license plates, people, signs placed on building fascia, house numbers, etc. In an example, a camera can be used to capture a digital image. Thereafter, for at least one pixel in the digital image, a gradient can be ascertained, wherein the gradient can be indicative of a rate of change of intensity values or color values of the at least one pixel with respect to adjacent or proximate pixels. For instance, gradient values can be ascertained for the at least one pixel in both a horizontal direction and a vertical direction. Pursuant to an example, a vertical gradient and a horizontal gradient can be determined for each pixel in the digital image or for each pixel in a defined area of the digital image.

Additionally, windows of pixels can be defined in the received digital image. For instance, a window may be a three pixel by three pixel window. In another example, size of a defined window may be based at least in part upon depth information, wherein the depth information is indicative of a distance between a digital camera and the object imaged by the digital camera. For example, depth information can be estimated using Light Detection and Ranging (LIDAR) scanner(s), depth sensing cameras, stereo cameras, structure light, usage of existing models of a region, buildings, etc., radar, fitting a plane to the road, etc. For each defined window of pixels, an average intensity value of pixels in a window can be determined. Furthermore, for each window of pixels, a median intensity value of pixels in the window of pixels can be determined.

A determination for each pixel may then be made regarding whether the pixel is a portion of a particular object, such as a license plate, based at least in part upon the gradient value(s) assigned to a pixel, an average intensity value for at least one window that includes the pixel, and/or a median intensity value for the at least one window that includes the pixel. For instance, for a particular pixel, if the vertical gradient value assigned thereto is above a defined threshold, if the horizontal gradient value assigned thereto is above a defined threshold, and if the ratio of average value to median value of a pixel window that includes the pixel is at or above a defined threshold, then the pixel can be labeled as corresponding to a certain object. In an example, threshold values can be modified depending upon an object being searched for in the digital image. As indicated above, in one example the threshold values for the horizontal and vertical gradient and the ratio between the average and median intensity values of defined windows of pixels can be set to locate license plates in a digital image. Further verification that a pixel or plurality of pixels is the particular object (e.g., a license plate) can be undertaken by identifying blank areas above and below an area that includes text. Additionally, verification may be done by identifying areas that cannot be the particular object as vegetation or large planes in the scene that could be the road or building facades.

Pursuant to another aspect described herein, once an object of interest has been located in a digital image such as a license plate, a street sign, a house number, etc. contents of such objects can be automatically blurred such that they are indecipherable to a review of the digital image. For instance, pixel intensity and/or color may be modified at locations corresponding to the identified object. Pursuant to an example, an amount of blurring undertaken with respect to a particular pixel or set of pixels may be based at least in part upon depth information pertaining to the object, wherein the depth information is indicative of a distance between the camera and the object imaged by such camera. For instance, an object further away from the camera would need less blurring to render the object indecipherable to the user.

Other aspects will be appreciated upon reading and understanding the attached figures and description.

### BRIEF DESCRIPTION OF THE DRAWINGS

FIG. 1 is a functional block diagram of an example system that facilitates capturing digital images.

FIG. 2 is a functional block diagram of an example system that facilitates automatically detecting a certain type of object in a digital image.

FIG. 3 is a functional block diagram of an example system that facilitates automatically blurring content of a digital image to render the content indecipherable to a reviewer.

FIGS. 4 and 5 depict examples of digital images.

FIG. 6 is flow diagram that illustrates an example methodology for labeling pixels in a digital image as corresponding to a particular type of object.

FIG. 7 is a flow diagram that illustrates an example methodology for automatically blurring a portion of a digital image.

FIG. 8 is a flow diagram that illustrates an example methodology for determining that a pixel corresponds to a certain type of object in a digital image.

FIG. 9 is an example computing system.

### DETAILED DESCRIPTION

Various technologies pertaining to automatically identifying certain types of objects in images and/or blurring a particular portion of an image will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

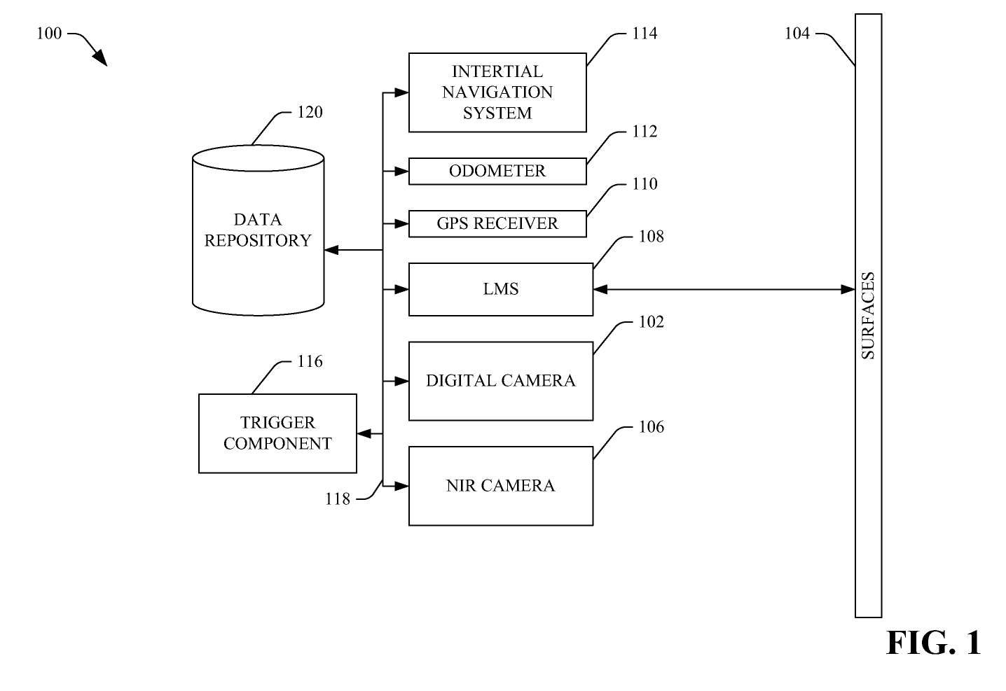

With reference to FIG. 1, an example system 100 that facilitates capturing digital images is illustrated. Pursuant to an example, the system 100 may be mounted on an automobile through use of any suitable mounting mechanism. Moreover, one or more components of the system 100 may be housed in a carbon fiber housing or other suitable housing.

The system 100 includes a digital camera 102 that is configured to capture images of at least one surface 104. In an example, the digital camera 102 may be configured to capture images of building facades but may also capture images of people, vehicles, street signs, house numbers, etc. The digital camera 102 may be configured to capture numerous images, and such images may be used in connection with generating a publicly accessible, three-dimensional model of a particular geographic region.

The system 100 may also include a near infrared (NIR) camera 106. The NIR camera 106 may be positioned proximate to the digital camera 102 such that the digital camera 102 and the NIR camera have a substantially similar field of view. Pursuant to an example, images captured by the NIR camera 106 may be used in connection with filtering vegetation or other objects found in images captured by the digital camera 102. Furthermore, the NIR camera 106 may provide NIR illumination for better detection of certain objects, such as license plates. License plates are made from retro-reflective material that can reflect much of the NIR illumination back toward the illumination source (the NIR camera 106), which can generate bright spots in an image wherever there are signs such as license plates (or traffic signs).

The system 100 may also include a laser measurement system (LMS) 108, which can be a LIDAR scanner. The LMS 108 may be configured to ascertain depth information between objects and the digital camera 102 (e.g., the depth information is indicative of a distance between a surface imaged by the digital camera 102 and the digital camera 102). For example, the LMS 108 can output a plurality of lasers in various directions to ascertain depth information pertaining to multiple objects captured in an image taken by the digital camera 102. Such depth information may be correlated to particular pixels in an image captured by the digital camera 102. While the system 100 is shown as including the LMS 108, it is to be understood that other systems/components may be used in connection with acquiring depth information pertaining to the digital camera 102 and surfaces imaged thereby. For instance, other depth sensing devices that may be used in connection with the system 100 include stereo cameras, structure light systems, time-of-flight cameras, radar, existing models, a module that can estimate distances by estimating planes on captured images (e.g., to represent a road or building facade), etc.

The system 100 can also include a GPS receiver 110 that can be configured to output location information pertaining to the system 100. An odometer 112 may also be used in connection with determining location information, velocity information, etc. Position may also be measured by other means such as triangulation from known points, or using other transmitted signals.

The system 100 may further include an inertial navigation system 114 that can be configured to output acceleration data, for example. Furthermore, the inertial navigation system 114 may be used in connection with outputting data indicative of a current orientation of the system 100 with respect to a reference coordinate system. Additionally or alternatively, images captured by the digital camera 102 can be analyzed, and location orientation can be determined by analyzing visible motion from captured images.

The system 100 may further include a trigger component 116 that can output trigger signals that can be received by at least one of the digital camera 102, the NIR camera 106, the LMS 108, the GPS receiver 110, the odometer 112 or the inertial navigation system 114. Pursuant to an example, the digital camera 102 may capture an image responsive to receipt of a trigger signal output by the trigger component 116. In another example, the LMS 108 may output depth data responsive to receipt of a trigger signal output by the trigger component 116. Pursuant to an example, the trigger component 116 can output trigger signals periodically. In another example, the trigger component 116 can output trigger signals upon receipt of data from one or more of the data sources of the system 100. For instance, the trigger component 116 may output trigger signals responsive to receipt of certain location data from the GPS receiver 110. The trigger component 116 may be in communication with one or more of the digital camera 102, the NIR camera 106, the LMS 108, the GPS receiver 110, the odometer 112 and/or the inertial navigation system 114 by way of a communication line 118. The communication line 118 may be any suitable communication line, such as a wireless line, Firewire, etc.

Additionally or alternatively, one or more of the sensors of the system 100 may output data responsive to an internal clock or otherwise independently of trigger signals output by the trigger component 116. For instance, the LMS 108 may be configured to acquire depth information periodically.

The system 100 can also include a data repository 120 that can receive and retain data output by the digital camera 102, the NIR camera 106, and/or the sensors 108 through 114. At least some of the contents in the data repository 120 may be synchronized through use of the trigger component 116. If data output by one or more of the components of the system 100 are not synchronized, time stamps can be assigned to data packets and synchronized at a later point in time.

In an example operation of the system 100, such system 100 may be mounted to a vehicle which travels over streets of a particular geographic region. As the vehicle travels the digital camera 102 can capture images of various surfaces/objects in response to trigger signals received by the trigger component 116. Images from the NIR camera 106, data from the LMS 108, data from the GPS receiver 110, data from the odometer 112 and/or data from the inertial navigation system 114 can correspond to one or more of the images captured by the digital camera 102.

Such images may be captured for the purpose of publishing on a publicly accessible web site, such as a mapping application. Images captured by the digital camera 102, however, may include data that may be considered private or sensitive. For example, an image captured by the digital camera 102 may include an automobile and a license plate that corresponds to the automobile. Furthermore an image captured by the digital camera 102 may include a house number or a sign that an owner would not wish to be displayed to the public by way of the Internet. Moreover, a significant number of images may be captured, rendering it inefficient to manually review each image to locate sensitive data.

While the system 100 has been shown and described with respect to static images captured by way of the digital camera 102, it is to be understood that the digital camera 102 may be a video camera that captures images at a video rate. Furthermore, images/video used in connection with detecting objects therein may originate from a camera or video camera that does not operate within the system 100. For instance, a home movie camera, a news camera, or other suitable camera can capture images, and such images can be analyzed for particular objects (e.g., license plates).

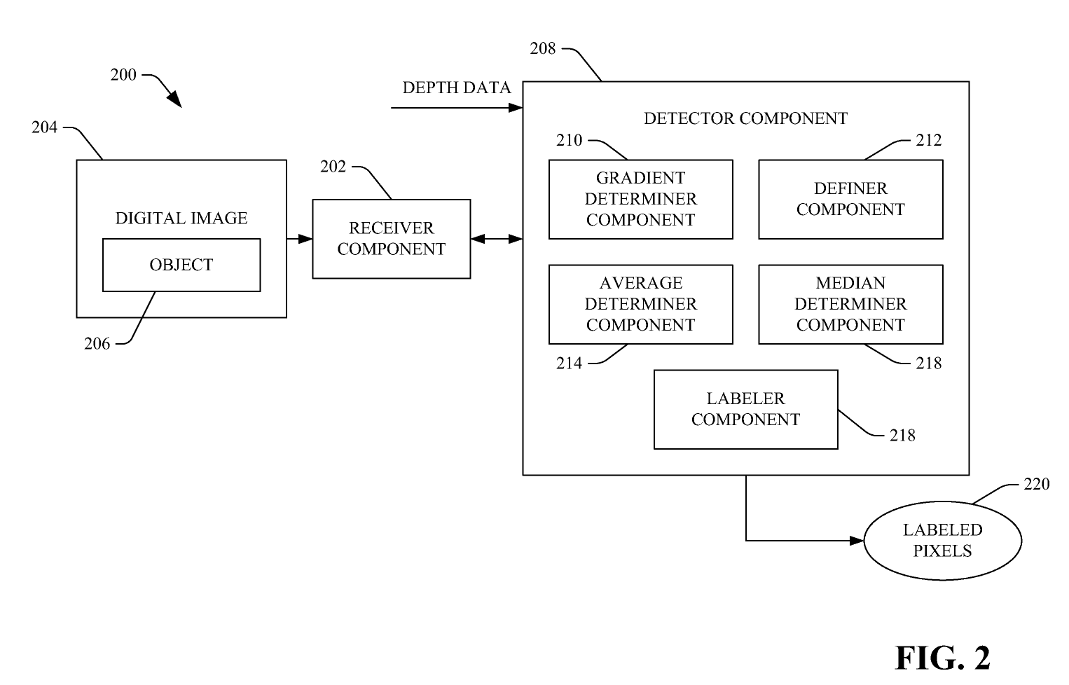

With reference now to FIG. 2, an example system 200 that facilitates automatically detecting existence certain objects in digital images is illustrated. The system 200 includes a receiver component 202 that receives a digital image 204, wherein the digital image 204 includes an object 206. For instance, the object 206 may be a license plate on a vehicle such as an automobile, a truck, a motorcycle, etc. In another example, the object 206 may be a person. In yet another example, the object 206 may be a sign on a building. In still yet another example, the object 206 may be a number on a residential building.

The system 200 may also include a detector component 208 that can automatically detect the object 206 in the digital image 204. For instance, if the object 206 is a license plate on a vehicle, the detector component 208 can be configured to ascertain that the object 206 is a license plate.

The detector component 208 may comprise a gradient determiner component 210 that can determine, for at least one pixel in the digital image 204, a gradient, wherein the determined gradient can be indicative of a rate of change of intensity or color values of the at least one pixel with respect to adjacent and/or proximate pixels in the digital image 204. Pursuant to an example, the gradient determiner component 210 can perform a scan in a vertical direction and in a horizontal direction over at least a portion of the digital image 204 to determine a horizontal gradient value for pixels in the digital image and a vertical gradient value for the pixels in the digital image 204. For instance, the gradient determiner component 210 may determine the horizontal gradient value for at least one pixel by analyzing a threshold number of pixels horizontally adjacent and/or proximate to the at least one pixel. In an example, the gradient determiner component 210 may use a derivation filter with a dimension of three pixels in the horizontal line. In another example, a size of the derivation filter used by the gradient determiner component 210 may be a function of depth of the pixel in the digital image 204 (e.g., a distance between the digital camera and the object represented by the at least one pixel, wherein the distance can be based at least in part upon data output by the LMS 108).

The gradient determiner component 210 may additionally compute a vertical gradient for the at least one pixel the digital image. For example, the gradient determiner component 210 may determine the vertical gradient value for at least one pixel by analyzing a threshold number of pixels vertically adjacent and/or proximate to the at least one pixel. As noted above, the gradient determiner component 210 may use a derivation filter with a dimension of three pixels in the vertical line. In another example, a size of the derivation filter used by the gradient determiner component 210 may be a function of depth of the pixel in the digital image 204.

The system 200 further includes a definer component 212 that defines windows of pixels in the digital image 204. For instance, a window of pixels may be a three pixel by three pixel window. In another example, the definer component 212 can define the size of a window of pixels based at least in part upon depth data corresponding to at least one pixel in the window of pixels (e.g., a defined window may be smaller for objects that are further away in the digital image 204 when compared to a defined size of window of pixels pertaining to objects that are closer in the digital image 204).

The detector component 208 can also include an average determiner component 214 that determines an average intensity value for pixels in a window of pixels defined by the definer component 212. The average value determined by the average determiner component 214 may be assigned to each pixel in the window of pixels. Pursuant to an example, the average determiner component 214 can perform a scan over the digital image 204 such that a single pixel may be in multiple windows. Accordingly, a pixel may be assigned multiple average values. A final value assigned to the pixel may be a highest value, a lowest value, a median value, an average value, etc. In another example, the average determiner component 214 can assign the determined average to a pixel in the center of the window of pixels. In yet another example, the average determiner component 214 can assign the determined average to a subset of pixels in the window of pixels.

The detector component 208 may also include a median determiner component 216 that determines a median intensity value of pixels in the window defined by the definer component 212. Again, each pixel in the window of pixels can be assigned the median value ascertained by the median determiner component 216. Again, a single pixel may reside in multiple windows of pixels, and thus the pixel may be assigned multiple values ascertained by the median determiner component 216. In such a case, the pixel can be assigned a highest value determined by the median determiner component 216 for the pixel, a lowest value, a median value, an average value, etc.

Thus, the at least one pixel can have assigned thereto a horizontal gradient value, a vertical gradient value, at least one average value determined by the average determiner component 214 and at least one median value determined by the median determiner component 216.

The detector component 208 can also include a labeler component 218 that automatically labels pixels in the digital image 204 as being a portion of the object 206 to output labeled pixels 220. The labeler component 218 can label pixels based at least in part upon the gradient value(s) determined by the gradient determiner component 210, an average value determined by the average determiner component 214, and/or a median value determined by the median determiner component 216. Pursuant to an example, for a particular pixel, the labeler component 218 can analyze a horizontal gradient value ascertained by the gradient determiner component 210 to determine whether such gradient value is above a threshold value. If such horizontal gradient value is not above the threshold value, the labeler component 218 can label the particular pixel as not being a portion of the object 206 in the digital image 204. If the horizontal gradient value is above the threshold, the labeler component 218 can analyze the vertical gradient value assigned to the particular pixel. If the vertical gradient value is not above a predefined threshold value (less than or equal to the threshold value used in connection with analyzing the horizontal gradient), the labeler component 218 can label the at least one pixel as not being a portion of the object 206 in the digital image 204.

If both the horizontal gradient value and the vertical gradient value are above the predefined threshold value(s), the labeler component 218 can analyze a ratio between an average value assigned to the particular pixel (determined by the average determiner component 214) and a median value assigned to the pixel (determined by the median determiner component 216). If the labeler component 218 determines that the average value is less than the median value, for example, then the labeler component can label the particular pixel as being a portion of the object 206 in the digital image 204. In another example, if the ratio is above a predefined threshold, the labeler component 218 can label the at least one pixel as being a portion of the object 206 in the digital image 204. Otherwise, the labeler component 218 can label the at least one pixel as not being a portion of the object 206 in the digital image 204.

The operation of the detector component 208 with respect to the at least one pixel described above can be undertaken for a plurality of pixels in a digital image 204. Thus, the detector component 208 can output the labeled pixels 220 wherein each of the labeled pixels 220 are labeled as being a portion of the object 206 or labeled as not being a portion of the object 206. Pursuant to an example, the detector component 208 can assign a label to each pixel in the digital image 204. In another example, the detector component 208 can analyze and assign labels to a subset of pixels in the digital image 204. For instance, if the detector component 208 is configured to detect license plates in the digital image 204, it may be assumed that existence of license plates may only occur in a certain portion of the digital image 204 (e.g., a bottom third of the digital image 204). Thus, the detector component 208 may analyze and label pixels in the bottom forty percent of the digital image 204 while not analyzing and labeling pixels in the upper sixty percent of the digital image 204. Of course, where the detector component 208 is configured to detect license plates in the digital image 204 may depend on the particular application and/or empirical data.

Furthermore, the average determiner component 214 may have an upper and/or lower bound on average values ascertained by such component 214. Additionally, the detector component 208 may consider chromatic constraints such as low chromatic variants with respect to license plate formats of specific regions. Moreover, the detector component 208 may remove noise in the labeled pixels by enforcing a minimum and/or maximum size requirement(s) (e.g., a threshold number of adjacent pixels being labeled as a portion of the object 206).

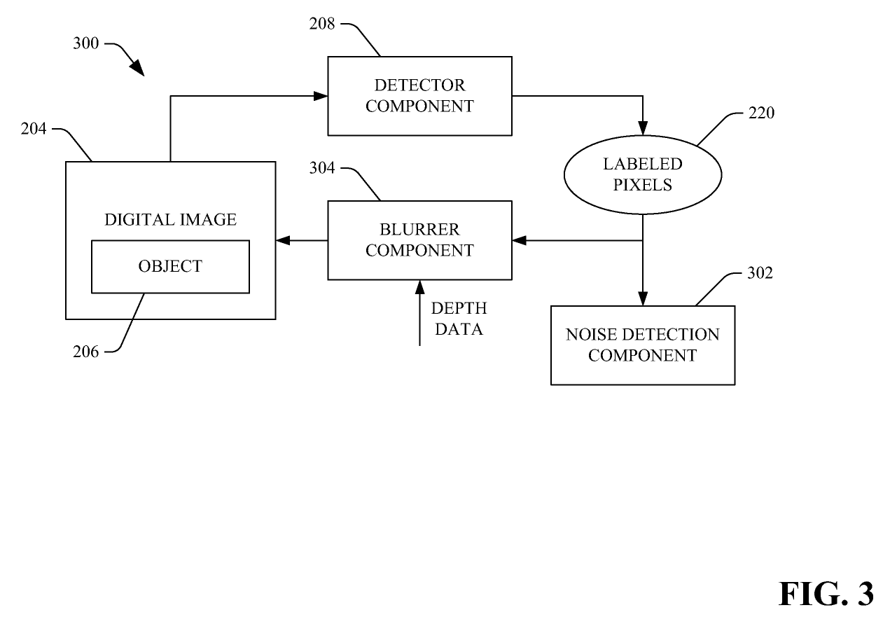

Referring now to FIG. 3, an example system 300 that facilitates blurring at least a portion of the digital image 204 based at least in part upon labels output by the detector component 208 is illustrated. The system 300 includes the detector component 208, which can analyze the digital image 204 and label pixels in the digital image 204 as being a portion of the object 206 in the digital image 204.

The system 300 further includes a noise reduction component 302 that can analyze the labeled pixels 220 and locate false positives therein. The noise reduction component 302 can detect false positives based at least in part upon depth data corresponding to the labeled pixels 220 as ascertained through analysis of data captured by the LMS 108. In another example, the noise reduction component 302 can detect false positives based at least in part upon image analysis corresponding to at least the labeled pixels 220, wherein such image analysis may include vegetation classification through any suitable technique.

In an example, the noise reduction component 302 can use depth information corresponding to pixels in digital images to ascertain/estimate/hypothesize a three-dimensional plane in the digital images. For instance, the digital image 204 may be analyzed with respect to at least one other digital image that has contents similar to the digital image 204 (e.g., the at least one other digital image may be captured using the digital camera 102 in the system 100 or another digital camera. A three-dimensional plane can be hypothesized in the at least one other digital image using depth information corresponding to the at least one other digital image from the LMS 108. An orientation between the at least one other digital image and the digital image 204 can be known, and the hypothesized plane from the at least one other digital image can be overlaid onto pixels in the digital image 204. If depth information of labeled pixels 220 in the digital image 204 correspond to depth information in the hypothesized plane, then it can be inferred that such pixels lie on a plane (e.g., and correspond to a building facade, a roadway, . . . ), and are not license plates or other objects of interest. Thus, the noise reduction component 302 can locate false positives in the labeled pixels through use of the hypothesized plane.

Moreover, the noise reduction component 302 can search for missing data from the LMS 108 with respect to pixels in the digital image 204 in connection with detecting false positives. For instance, typically the LMS 108 does not return depth data when directed at glass or a highly reflective object (e.g., shiny paint of an automobile). Thus, when pixels in the digital image 204 do not correspond with depth data from the LMS 108, an inference can be made that such pixels correspond to an automobile. Thus, it can be inferred that pixels proximate to pixels that do not have depth data may correspond to license plates. Similarly, an inference can be made that a false positive exists in the labeled pixels 220 if such pixels are not proximate to pixels that are not associated with depth data from the LMS 108.

In still yet another example, the noise reduction component 302 can assign confidence scores to the labeled pixels 220, such that each of the labeled pixels 220 is assigned a confidence score. The noise reduction component 302 may then detect false positives based at least in part upon the confidence scores corresponding to the labeled pixels 220. The confidence scores can be based at least in part upon any suitable combination of depth data from the LMS 108 corresponding to certain pixels, vegetation classification data, lack of data from the LMS 108 from particular pixels, data pertaining to a hypothesized plane, etc. For instance, a labeled pixel can initially be assigned a relatively high confidence score. If the labeled pixel is classified as vegetation, the confidence score can be decreased. If the labeled pixel is not close to pixels that are not associated with depth data, the confidence score can be decreased, etc. Once a final confidence score is assigned to the pixel, the noise reduction component 302 can determine whether to label the pixel as a false positive based at least in part upon the confidence score.

The noise reduction component 302 can also analyze collections of labeled pixels in certain regions and can impose a size restriction on labeled pixels. For instance, the noise reduction component 302 can ensure that pixels labeled as being a portion of a sensitive object are grouped with a certain number of other pixels.

The system 300 also includes a blurrer component 304 that can receive the labeled pixels 220 and blur pixels in the digital image 204 that correspond to pixels labeled as being a portion of the object 206 (and not identified as being a false positive by the noise reduction component 302). For instance, the object 206 may be a license plate and the blurrer component 304 can blur digits of the license plate to cause such digits to be indecipherable to a reviewer of the digital image 204.

In an example, the blurrer component 304 can blur pixels based at least in part upon size of the object 206 in the digital image 204. For instance, if the detector component 208 detects that the object 206 is relatively small, then the blurrer component 302 may not significantly blur the object 206 in the digital image 204 (as digits in the object 206 may already be indecipherable). If, however, the object 206 is detected as being relatively large (e.g., covering a threshold number of pixels), then the blurrer component 304 can significantly blur the object 206 to render it indecipherable to a reviewer of the digital image 204.

In another example, the blurrer component 304 can blur the object 206 in the digital image 204 based at least in part upon depth data (e.g., ascertained from the LMS 108 of FIG. 1). For example, the object 206 may have been a relatively large distance from the digital camera 102 when the digital camera 102 captured the digital image 204 (which can be ascertained by reviewing depth data). Thus, the blurrer component 304 does not significantly blur the object 206 in the digital image 204. In yet another example, the depth data may indicate that the object 206 was relatively close to the digital camera 102 when the image 204 was captured. Accordingly, the blurrer component 302 can significantly blur the object 206 to cause it to be indecipherable to a reviewer of the digital image 204.

In still yet another example, the blurrer component 304 may alter how a portion of an image is blurred based upon location pertaining to an identified object. For instance, the blurrer component 304 may cause blurring to be constant or stronger in the middle of an identified object and gradually change blurring near the edges of the identified object (e.g., the blurrer component 304 may blur pixels near the center of the identified object more than pixels near an edge of the identified object). Other techniques are also contemplated in connection with causing a portion of an image to be visually altered/indecipherable to a reviewer, including scrambling of pixels in an identified object, lowering resolution with respect to pixels corresponding to an identified object in an image, and/or covering identified objects with a pattern.

For instance, it may be known that at a particular distance, a digit in a license plate may appear to be a certain size in the digital image 204. Accordingly, the blurrer component 302 can access a table of blurring parameters, wherein such blurring parameters are based at least in part upon received depth data corresponding to the object 206 in the digital image 204 and the digital camera 102. Upon receipt of such depth data, the blurrer component 302 can access the blurring parameters table and select a blurring parameter to use when blurring the object 206 in the digital image 204.

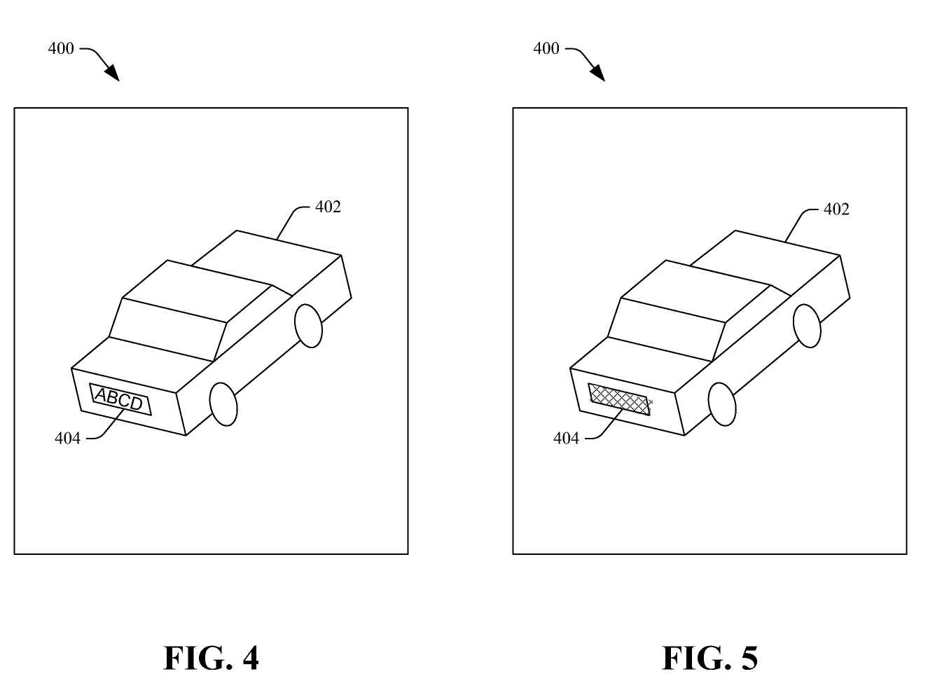

With reference now to FIG. 4, an example digital image 400 is illustrated. The digital image 400 includes an image of a vehicle 402 that has a license plate 404 thereon. The detector component 208 (FIG. 2) can detect the existence of the license plate 404 on the vehicle 402 in the digital image 400 even though the license plate 404 is at an oblique angle from the digital camera used to capture the digital image 400.

Referring briefly to FIG. 5, the digital image 400 is illustrated after the blurrer component 304 (FIG. 3) has blurred the license plate 404. As can be ascertained, the license plate 404 has been blurred such that digits thereon are indecipherable.

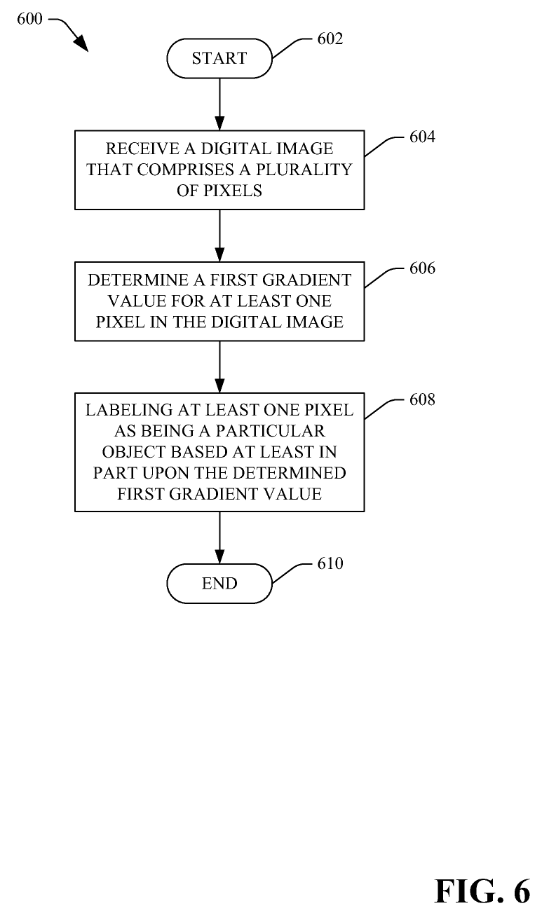

With reference now to FIGS. 6-8, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring now to FIG. 6, a methodology 600 that facilitates automatically detecting an object in a digital image is illustrated. The methodology 600 begins at 602, and at 604 a digital image is received, wherein the digital image comprises a plurality of pixels.

At 606, a first gradient value for at least one pixel in the plurality of pixels in the digital image is determined. For instance, the first gradient value may be a horizontal gradient value and may be representative of a rate of change of intensity or color values of the pixel with respect to at least one adjacent pixel in the horizontal line that includes the at least one pixel. In another example, the first gradient value may be a vertical gradient value that is representative of the rate of change of intensity or color of the at least one pixel with respect to another pixel in the same vertical line as the at least one pixel. Pursuant to an example, the first gradient value can be determined through use of a derivation filter of a threshold size or of a size that is based upon depth data corresponding to the digital image.

At 608, the at least one pixel is labeled as being a particular object based at least in part upon the determined first gradient value for the at least one pixel. In an example, the at least one pixel can be labeled as being a portion of a license plate included in the digital image. The methodology completes at 610.

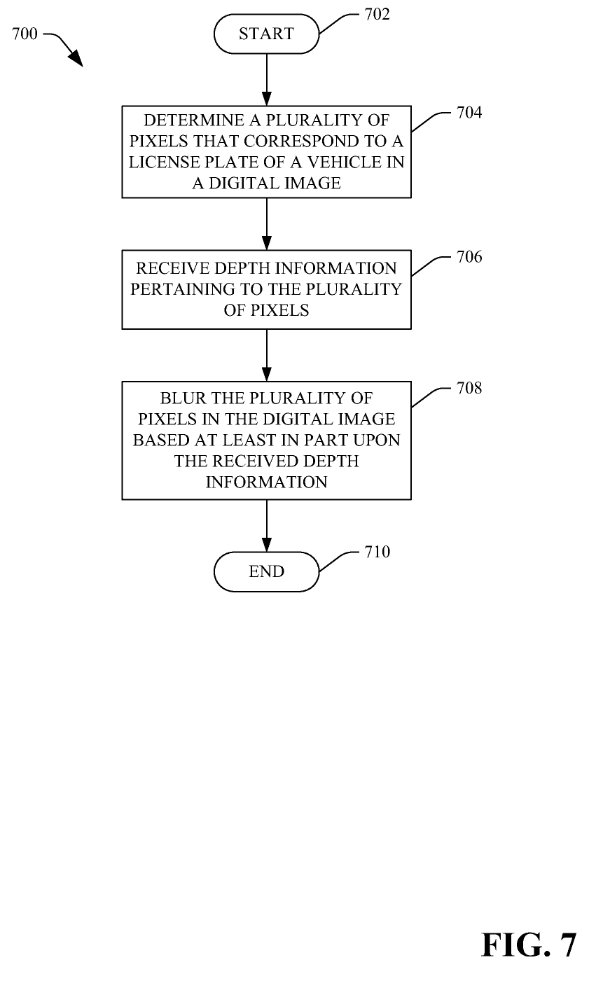

With reference now to FIG. 7, an example methodology 700 that facilitates automatically blurring a portion of a digital image is illustrated. The methodology 700 starts at 702, and at 704 a determination is made that a plurality of pixels in a digital image correspond to a license plate of a vehicle. Such an example determination has been described above.

At 706, depth information is received pertaining to the plurality of pixels. For instance, a laser measurement system can be used in connection with determining a distance between the digital camera and an object imaged by the digital camera.

At 708, the plurality of pixels in the digital image that correspond to the detected license plate are blurred based at least in part upon the received depth information. For instance, if the depth information is relatively large the license plate may not be significantly blurred. If the depth information is relatively small, thereby indicating that the detected license plate was close to the digital camera when the digital image was captured (thereby having a higher probability of being decipherable by a reviewer of the digital image), the plurality of pixels may be significantly blurred. The methodology 700 completes at 710.

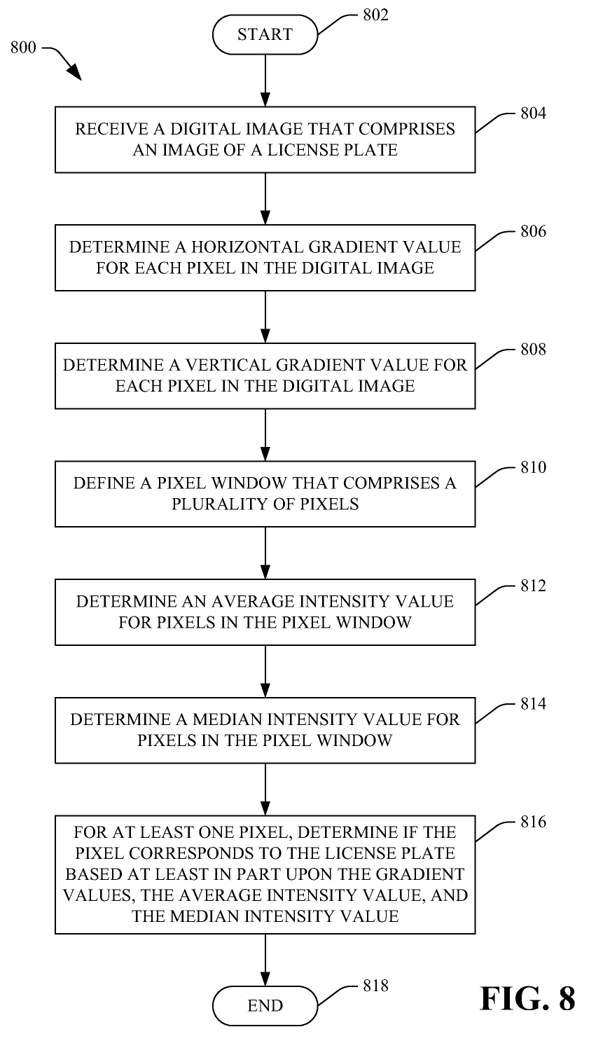

Referring now to FIG. 8, an example methodology 800 that facilitates determining whether a pixel corresponds to a license plate in a digital image is illustrated. The methodology 800 starts at 802, and at 804 a digital image is received, wherein the digital image comprises an image of a license plate of a vehicle.

At 806, a horizontal gradient value is determined for pixels in the digital image. Thus, a plurality of pixels can have horizontal gradient values assigned independently thereto. As noted above, the horizontal gradient value can be indicative of a rate of change of intensity of a pixel with respect to at least one other pixel in a horizontal direction from such pixel in the digital image.

At 808, a vertical gradient value is determined for the pixels. Thus, again, each of the pixels can have a vertical gradient value independently assigned thereto. The vertical gradient values can be indicative of a rate of change of intensity of a pixel with respect to at least one other pixel in a vertical direction in the digital image.

At 810, a pixel window is defined that comprises multiple pixels. For instance, size of the pixel window may be three pixels by three pixels, may depend upon depth data corresponding to pixels, etc. Furthermore, a scan can be undertaken such that a single pixel is included in a plurality of defined windows.

At 812, an average intensity value is determined with respect to the multiple pixels in the defined pixel window. For instance, such average intensity value may be upper-bounded and/or lower bounded with respect to gray values.

At 814, a median intensity value of the multiple pixels in the pixel window can be determined. Thus, a pixel can be assigned a horizontal gradient value, vertical gradient value, at least one average value and at least one median value.

At 816, for at least one pixel in the digital image, a determination is made regarding whether the pixel corresponds to the license plate, wherein such determination is made based at least in part upon the horizontal gradient value, the vertical gradient value, the average intensity value for pixels in the pixel window that includes the at least one pixel and the median intensity value for the plurality of pixels in the pixel window that includes the at least one pixel. If it is ascertained that the pixel corresponds to the license plate, such pixel can be assigned a label that indicates that the pixel corresponds to the license plate. Thereafter, the at least one pixel may be subjected to a blurring procedure. The methodology 800 completes at 816.

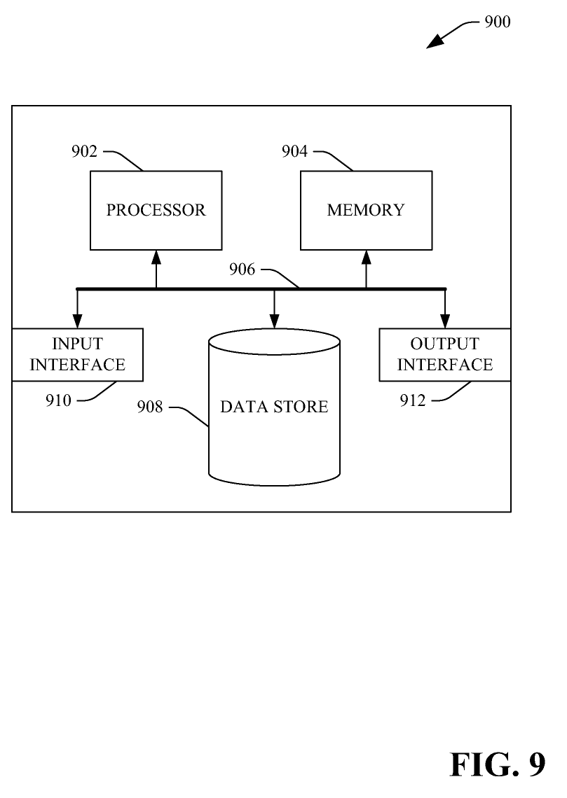

Now referring to FIG. 9, a high-level illustration of an example computing device 900 that can be used in accordance with the systems and methodologies disclosed herein is illustrated. For instance, the computing device 900 may be used in a system that supports automatically determining whether one or more pixels in a digital image corresponds to a particular object such as a license plate. In another example, at least a portion of the computing device 900 may be used in a system that supports automatically blurring an object in a digital image. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store digital images, gradient values, average values, median values, etc.

The computing device 900 additionally includes a data store 908 that is accessible by the processor 902 by way of the system bus 906. The data store 908 may include executable instructions, digital images, blurring parameters, gradient values, medina values, etc. The computing device 900 also includes an input interface 910 that allows external devices to communicate with the computing device 900. For instance, the input interface 910 may be used to receive instructions from an external computer device, from a digital camera, etc. The computing device 900 also includes an output interface 912 that interfaces the computing device 900 with one or more external devices. For example, the computing device 900 may display text, images, etc. by way of the output interface 912.

Additionally, while illustrated as a single system, it is to be understood that the computing device 900 may be a distributed system. Thus, for instance, several devices may be in communication by way of a network connection and may collectively perform tasks described as being performed by the computing device 900.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising the following computer-executable acts:
receiving a digital image that comprises a plurality of pixels;
determining a first gradient value for at least one pixel in the plurality of pixels; and
labeling the at least one pixel as being a particular object based at least in part upon the determined first gradient value for the at least one pixel.

2. The method of claim 1, further comprising:
determining a second gradient value for the at least one pixel in the plurality of pixels; and
labeling the at least one pixel as being the particular object based at least in part upon the determined second gradient value for the at least one pixel.

3. The method of claim 2, wherein the first gradient value is a horizontal gradient value and the second gradient value is a vertical gradient value.

4. The method of claim 3, wherein the at least one pixel is labeled as being a portion of a license plate of a vehicle.

5. The method of claim 4, wherein the first gradient value and the second gradient value are one of intensity gradient values or color gradient values.

6. The method of claim 5, further comprising:
defining a window of pixels that includes a plurality of pixels, wherein the at least one pixel is included in the window of pixels;
determining an average intensity value for the plurality of pixels in the window of pixels;
determining a median intensity value for the plurality of pixels in the window of pixels; and
labeling the at least one pixel as being the particular object based at least in part upon the determined average intensity value and the determined median intensity value.

7. The method of claim 1, further comprising:
determining gradient values for a plurality of pixels in the digital image; and
labeling a subset of the plurality of pixels in the digital image as being at least a portion of the object.

8. The method of claim 7, further comprising visually altering the subset of the plurality of pixels in the digital image to cause at least a portion of the digital image to be blurred.

9. The method of claim 8, further comprising:
analyzing distance data representative of distance between a camera that captured the digital image and the object; and
visually altering the subset of the plurality of pixels based at least in part upon the analyzed distance.

10. The method of claim 1, wherein the gradient is a rate of change of intensity pertaining to the pixel with respect to at least one other pixel.

11. The method of claim 1, wherein the object is a number on a house or a sign on a building facade.

12. The method of claim 1, further comprising:
defining a portion of the digital image that possibly includes the object; and
executing scans horizontally and vertically only in the portion of the digital image that possibly includes the object to determine horizontal and vertical gradient values for each pixel in the portion of the digital image that possibly includes the object.

13. The method of claim 1, further comprising:
analyzing distance data between a camera that captured the digital image and the object; and
labeling the pixel as the object based at least in part upon the analyzed distance.

14. The method of claim 1, further comprising:
analyzing the digital image to determine one or more planes in the digital image; and
labeling the pixel as being at least a portion of the object based at least in part upon the one or more determined planes.

15. A system comprising the following computer-executable components:
a detector component that automatically determines location of a license plate in a digital image; and
a blurrer component that automatically blurs the digital image at the determined location of the license plate, wherein blurring undertaken by the blurrer component is based at least in part upon confidence scores assigned to pixels in the digital image that correspond to the determined location of the license plate.

16. The system of claim 15, wherein the detector component comprises:
a gradient determiner component that determines a horizontal gradient value and a vertical gradient value for at least one pixel in the digital image; and
a labeler component that automatically labels the at least one pixel in the digital image as being the license plate of the vehicle based at least in part upon the determined horizontal gradient value and the determined vertical gradient value.

17. The system of claim 16, wherein the confidence scores are based at least in part upon depth data corresponding to the pixels.

18. The system of claim 16, wherein the horizontal gradient value represents a rate of change in intensity of the at least one pixel with respect to at least one other pixel located horizontally from the at least one pixel and the vertical gradient value represents a rate of change of intensity of the at least one pixel with respect to at least one other pixel located vertically from the at least one pixel.

19. The system of claim 18, wherein the detector component further comprises:
a definer component that defines a window of pixels that includes the at least one pixel;
an average determiner component that determines an average intensity value of pixels in the window of pixels; and
a median determiner component that determines a median intensity value of pixels in the window of pixels, wherein the labeler component labels the at least one pixel as being a portion of the license plate based at least in part upon the determined average intensity value and the determined median intensity value.

20. A computer-readable medium comprising instructions that, when executed by a processor, perform the following acts:
receiving a digital image, wherein the digital image comprises an image of a license plate;
determining horizontal gradient values for a plurality of pixels in the digital image, wherein a horizontal gradient value is representative of a rate of change of intensity of a pixel with respect to at least one other pixel in a horizontal direction in the digital image;
determining vertical gradient values for the plurality of pixels in the digital image, wherein a vertical gradient value is representative of a rate of change of intensity of a pixel with respect to at least one other pixel in a vertical direction in the digital image;
defining a pixel window that comprises multiple pixels;
determining an average intensity value of the multiple pixels in the pixel window;
determining a median intensity value of the multiple pixels in the pixel window;
for at least one pixel in the digital image, determining whether the at least one pixel is included in the image of the license plate based at least in part upon the horizontal gradient value for the at least one pixel, the vertical gradient value for the at least one pixel, the average intensity value of the multiple pixels in the pixel window, wherein the pixel window includes the at least one pixel, and the median intensity value for the plurality of pixels in the pixel window that includes the at least one pixel; and
labeling the pixel as being included in the image of the license plate.
